(19) United States
(12) Patent Application Publication
(10) Pub. No.: US 2013/0291802 A1
(43) Pub. Date: Nov. 7, 2013

(54) Multi-Compartment Pet Water Bowl

(71) Applicant: Diane Carpentieri, Greenport, NY (US)

(72) Inventor: Diane Carpentieri, Greenport, NY (US)

(21) Appl. No.: 13/872,335

(22) Filed: Apr. 29, 2013

Related U.S. Application Data
(60) Provisional application No. 61/641,537, filed on May 2, 2012.

(51) Int. Cl. A01K 7/00

(52) U.S. Cl. CPC A01K 7/00
USPC 119/72

(57) ABSTRACT

Disclosed is a multi-compartment water bowl for a pet, comprising a top compartment having an open top and an annular sidewall that is adapted to receive water therein, a bottom compartment, having a lid and a removable filling door, a divider that separates the top and bottom compartments, an access point in the divider between the top and bottom compartments, a stopper that sealingly covers said access point, and an attachable lid for sealingly covering the top compartment open top. The device can alternatively utilize a pair of filling tubes disposed between the top and bottom compartments for allowing water to flow therethrough. A user can fill the bottom compartment with ice, water, or combination thereof, and seal the door, which retains the water in the bottom compartment for later use.

### CROSS REFERENCE TO RELATED APPLICATION

This application claims the benefit of U.S. Provisional Application No. 61/641,537 filed on May 2, 2012, entitled “Kool Dog.” The above identified patent application is herein incorporated by reference in its entirety to provide continuity of disclosure.

### BACKGROUND OF THE INVENTION

1. Field of the Invention

The present invention relates to a pet water bowl. More particularly, it pertains to a multi-compartment water bowl for a pet that provides pets with access to chilled water when traveling.

Many pet owners enjoy spending time with their pets, both inside and outside the home. This often involves traveling with pets. From a visit to a local dog park to cross country trips, pets often accompany their owners to a variety of locations. This requires forethought with respect to caring for the pet, particularly regarding proper hydration, as it may be difficult to locate a source of water for pets when traveling.

When at home, pets tend to sip on water throughout the day. It is well known that dogs drink approximately one ounce of water per pound of body weight per day. This number can increase greatly in the heat. When traveling during the summer months, a dog may become overheated easily and require larger than normal quantities of water. The excitement of traveling to new places and the heat can quickly dehydrate pets, which can become problematic when access to water is limited. In addition to extended trips, pets can also become dehydrated when traveling locally to dog parks. The excitement of running freely with other dogs can quickly lead to exhaustion and the need for water. While many dog parks have readily available sources of water, it is not prudent to assume that water will always be available.

Without adequate water, pets are prone to constipation and overheating. It can be inconvenient to carry large quantities of water when traveling, particularly on extended trips. This often requires frequent stops for water. It is recommended that pet owners avoid giving tap water to pets from the locations when stopping, since these sources of water can upset a pet's stomach, in the way that changing food brands or formulas does.

To prevent overheating and dehydration when traveling, pet owners are recommended to provide their pets with constant access to water for proper hydration. This requires that an owner bring a water bowl when traveling. Traveling water bowls, however, can easily be spilled, and do not hold sufficient quantities of water for extended trips. In addition to water, pet owners can place ice cubes into their pet's water bowls, which provides a means of keeping the water cold for an extended period of time as the ice melts. This can be difficult when traveling, as it requires a separate place for ice storage.

The present invention provides a pet water bowl that can be used to provide pets with constant access to water when traveling. The device comprises a pet bowl having a divider that creates a top and bottom compartment. In a first embodiment, a stopper provides an access point between compartments, which allows water to move therebetween. In a second embodiment, a pair of filling tubes allows water to flow from the bottom compartment and into the top. A user can fill the bottom compartment with ice, water, or combination thereof, and seal the door, which retains the water for later use. The user can then cause the water or melted ice to flow from the bottom compartment to the top for consumption.

2. Description of the Prior Art

Devices have been disclosed in the prior art that relate to bowls. These include devices that have been patented and published in patent application publications. These devices generally relate to bowls that are used for supplying food and water to pets. The following is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 5,209,184 to Sharkan discloses a water and/or food bowl for a pet, such as a dog, which has a container portion with an open top surrounded by a skirt portion. The open top is adapted to receive food or water therethrough with the skirt portion terminating in a ring-shaped lower edge at or below the lower most extent of the container. The bowl also includes a lid for sealingly covering the open top of the container portion and a fastener for securing the bowl to a surface to prevent any movement of the bowl on the surface. While the Sharkan device discloses a combination water and food bowl with a lid, it does not, however, describe a multi-compartment bowl with a compartment for holding ice or water for later use, a filling door for filling, or a means of transferring water from the top compartment to the bottom.

Additionally, U.S. Published Application Publication No. 2010/0077963 to Lipscomb discloses a pet feeding system that includes a dish configured to regulate intake of food by a pet. The dish includes a housing in cooperation with a food-dispensing receptacle that dispenses food into a food-receiving chamber within the housing, permitting a pet to access food in the chamber through at least one food access port that only permits part of the pet to reach within the housing to get food. The food-dispensing receptacle can be a bowl that can be integrally formed as part of the housing and can also be a food-holding container that seats in the bowl. A cap is provided that can cover food in the bowl or container preventing a pet from accessing the food. Similar to Sharkan, the Lipscomb device discloses a pet food bowl with a lid. The device does not disclose a multi-compartment bowl utilizing a stopper or pair of filling tubes to allow water or melted ice to flow from one compartment to the other.

U.S. Published Application Publication No. 2010/0122660 to Willett discloses an on demand food and water dispenser for pets, comprising a base structure capable of holding water, a food bowl, and a dual-chambered container attached within the base structure and capable of receiving, storing and dispensing on demand dry pet food into the food bowl and on demand water into the base structure. The base structure receives dispensed water from the second chamber to create a water-filled moat that inhibits crawling insects from accessing the food bowl or food stored in the first chamber of the dual chambered container. While the Willett device describes an apparatus wherein water travels from a storage location to a drinking location, it does not disclose the structure and intent of the present invention. The Willett device utilizes a base water receiving chamber for directing water, via gravity flow, from the water container into the water bowl. The present invention utilizes a multi-compartment bowl with a bottom compartment for holding water, and an opening in the bottom for filling with ice or water. When the bowl is inverted, melted ice water flows from the top compartment to the bottom compartment.

Similar to the Willett device, U.S. Pat. No. 3,340,851 to Frank discloses a feeder cabinet having a food hopper therein for storing enough animal food for at least several days of feeding. Rotatably mounted in the cabinet below a dispensing outlet nozzle on the hopper is a plate having a plurality of food containers mounted thereon. The device includes a means for rotating the plate whereby the containers will successively be registered with the dispensing nozzle for receiving food from the hopper. Also included in the cabinet is a water feeder operated by a floating valve to maintain a constant amount of water in a separate compartment of the food dish. The Frank device is designed for automatically feeding a pet over a span of several days. It is intended to be used in a singular location, and is not adapted for use when traveling.

U.S. Pat. No. 8,006,513 to Roth discloses a food storage system that includes a main bowl defining a first food receiving cavity. A secondary bowl is positioned in the first food receiving cavity and defines a second food receiving cavity. The secondary bowl includes a sidewall containing thermal energy storage material therein. A separate food storage system includes a main lid configured for use with a main bowl that defines a first food receiving cavity. A secondary bowl is positioned at least partially on and/or in the main lid. The secondary bowl includes a sidewall containing thermal energy storage material therein. While the Roth device discloses a multi-compartment storage device, it is designed to store food in a first compartment, and a thermal energy material for heating and/or cooling associated food in a second compartment. It is not designed for use as a travel water bowl for a pet that enables ice to melt and flow from a top compartment to a bottom compartment.

The devices disclosed in the prior art describe pet bowls that provide a source of food and water thereto. The primary function of such devices is to provide a container for housing food and water that is necessary for proper nutrition and hydration. These devices, however, do not disclose a multi-compartment water bowl for a pet that allows for ice that is stored in a bottom compartment to melt and flow into the top compartment for consumption. In light of the prior art and the disclosed elements of the present invention, it is submitted that the present invention substantially diverges in design elements from the prior art. Consequently, it is clear that the present invention is not described by the art and that a need exists for an improved multi-compartment water bowl for a pet. In this regard, the instant invention substantially fulfills these needs.

### SUMMARY OF THE INVENTION

In view of the foregoing disadvantages inherent in the known types of pet bowls now present in the prior art, the present invention provides a new multi-compartment water bowl for a pet wherein the same can be utilized for providing convenience for the user when providing a supply of water to a pet.

It is therefore an object of the present invention to provide a new and improved multi-compartment water bowl for a pet device that has all of the advantages of the prior art and none of the disadvantages.

It is another object of the present invention to provide a new and improved multi-compartment water bowl for a pet having a divider that creates a top and bottom compartment.

Another object of the present invention is to provide a new and improved multi-compartment water bowl for a pet that provides chilled water for a pet to consume in remote locations.

Another object of the present invention is to provide a new and improved multi-compartment water bowl for a pet having a stopper that provides an access point between compartments, which allows water to move therebetween.

Yet another object of the present invention is to provide a new and improved multi-compartment water bowl for a pet having a pair of filling tubes that allow water to flow from the bottom compartment and into the top.

Another object of the present invention is to provide a new and improved multi-compartment water bowl for a pet having an insulated lid for preventing the ice contained therein from rapidly melting.

A final object of the present invention is to provide a new and improved multi-compartment water bowl that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the present invention with the lid removed and the stopper installed therein.

FIG. 2 shows a perspective view of the present invention with the filling door removed and ice contained therein.

FIG. 3 shows a perspective view of an alternate embodiment of the present invention, wherein a first and second filling tube is used to transfer water into the top compartment.

FIG. 4 shows a perspective view of an alternate embodiment of the present invention, wherein water is traveling through the first filling tube into the top compartment from the bottom compartment.

### DETAILED DESCRIPTION OF THE INVENTION

Reference is made herein to the attached drawings. Like reference numerals are used throughout the drawings to depict like or similar elements of the pet watering bowl. For the purposes of presenting a brief and clear description of the present invention, the preferred embodiment will be discussed as used for providing water to pets in remote locations. The figures are intended for representative purposes only and should not be considered to be limiting in any respect.

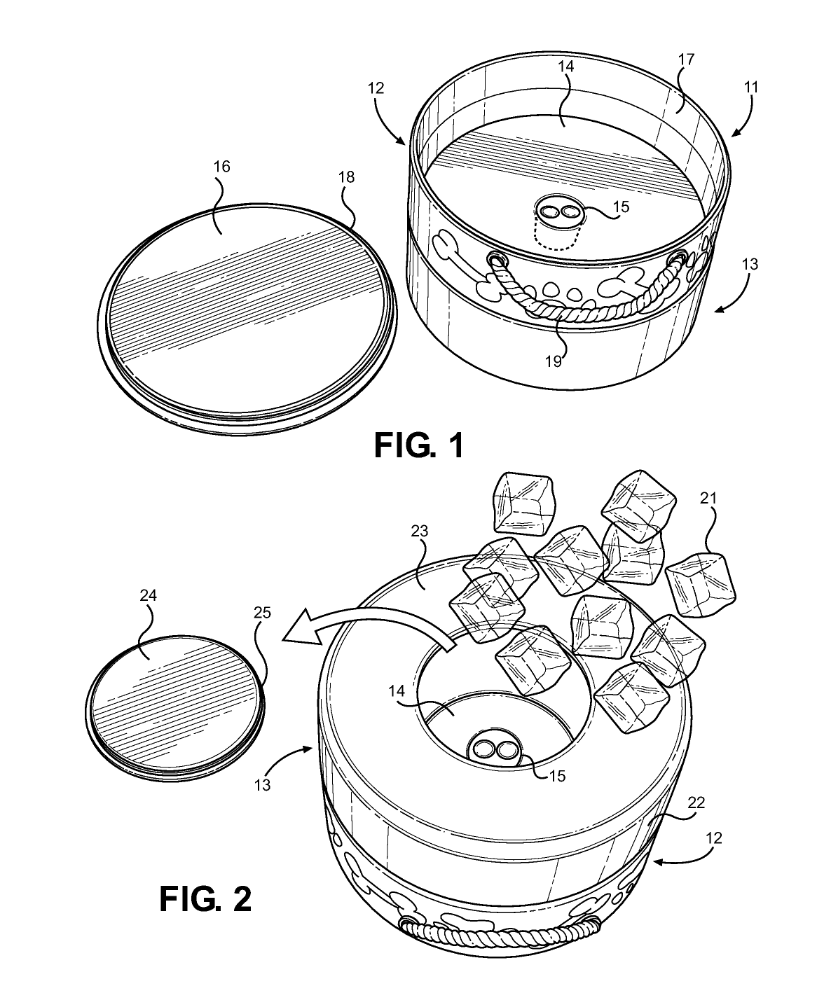

Referring now to FIG. 1, there is shown a perspective view of the present invention, which is comprised of a pet bowl 11 having a top compartment 12 and a bottom compartment 13. A divider 14 separates the top and bottom compartments to create two distinct areas within the bowl. A stopper 15 provides an access point between compartments, which allows water to move therebetween. The bottom compartment includes a removable filling door (not shown) for providing access to the interior thereof. A user can fill the bottom compartment with ice, water, or combination thereof, and seal the door, which retains the water in the bottom compartment for later use. The stopper can be removed from the divider, and the device can be inverted, which allows water and/or melted ice to flow from the bottom compartment to the top. Once a sufficient amount of water is contained within the top compartment, the user can replace the stopper, invert the device, and remove the lid 16 from the top compartment. This provides cold water for a pet that can be easily transported to a desired location for drinking where access to fresh water would otherwise be limited.

The top compartment includes an open top and an annular sidewall 17 that is adapted to receive water. The device is large enough to be used as a water bowl for a domestic pet, such as a dog, and can hold a sufficient amount of liquid to provide an adequate supply of drinking water for the animal. The top compartment further includes a means of sealingly covering the open top with an attachable lid. In the preferred embodiment, the lid attaches to the open top with a means of engaging the side wall to create an airtight seal, or another suitable means of attachment. The lid can additionally include a rubber seal 18 around the edge thereof, which helps the lid to properly engage the top compartment in order to prevent water from leaking therethrough.

The top compartment additionally includes a stopper that sealingly covers in the divider. The stopper creates a seal between the top and bottom compartments, and prevents any liquids from traveling therebetween. The stopper is pressure fit into an opening in the divider to create a seal, which enables a user to fill the top compartment and to keep it separate and distinct from the bottom. The stopper can be removed from the divider, which creates an opening between the top and bottom compartments, thereby allowing a liquid to travel therebetween.

The device further includes a means of transporting the pet bowl. In the preferred embodiment, the means of transporting the bowl comprises a carrying handle 19 affixed to either side of the top compartment. The carrying handle can be used to grasp the device for transport, and additionally provides a means of determining the orientation of the bowl. Because the handle is affixed to the top compartment, it serves as an indicator to the user as to whether the top or bottom compartment is facing up. This ensures that the user does not place the bowl upside down when providing a drink for his or her pet. Additionally, the handle can be used as an anchoring point, whereby a user can tie a rope or other tethering device to the bowl in order to prevent it from being misplaced or inadvertently moved.

Referring now to FIG. 2, there is shown a perspective view of the present invention with the filling door removed and ice contained therein. The bottom compartment 13 is adapted for holding ice cubes 21 therein, which can melt to provide cold water to the pet. The bottom compartment includes an annular sidewall 22 that extends from the divider 14, and is similar in size to the top compartment 12. The bottom compartment preferably includes a means of preventing the ice cubes contained therein from rapidly melting. In the preferred embodiment, the bottom compartment includes an insulated lid 23 that helps to retain the cold temperature of the ice for an extended period of time. This is particularly beneficial for use in warm climates, where ice can rapidly melt due to exterior temperatures.

The insulated lid further includes a filling door 24 that is removably attached thereto for providing access to the interior of the bottom compartment. The filling door attaches to the insulated lid with a means of engaging the side wall to create an airtight seal, or another suitable means of attachment. The filling door can additionally include a rubber seal 25 around the edge thereof, which helps the lid to properly engage the bottom compartment lid in order to prevent water from leaking therethrough.

In operation, a user can position the pet bowl so that the bottom compartment is facing up, remove the filling door, fill the bottom compartment with water or ice, and close the door. The user can then travel with the pet bowl to a desired location. When the pet requires water, the user can orient the device so that the top compartment is facing up, open the lid, remove the stopper 15, close the lid, and invert the device so that the bottom compartment is now facing up. Once the device is inverted, the water or melted ice will travel from the bottom compartment and into the top compartment. After a sufficient amount of water or melted ice has accumulated in the top compartment, the user can remove the filling door from the bottom compartment, replace the stopper, and close the filling door. The user can then invert the device so that the top compartment is facing up, and remove the lid. The water is contained within the top compartment, which is then accessible for the pet to consume.

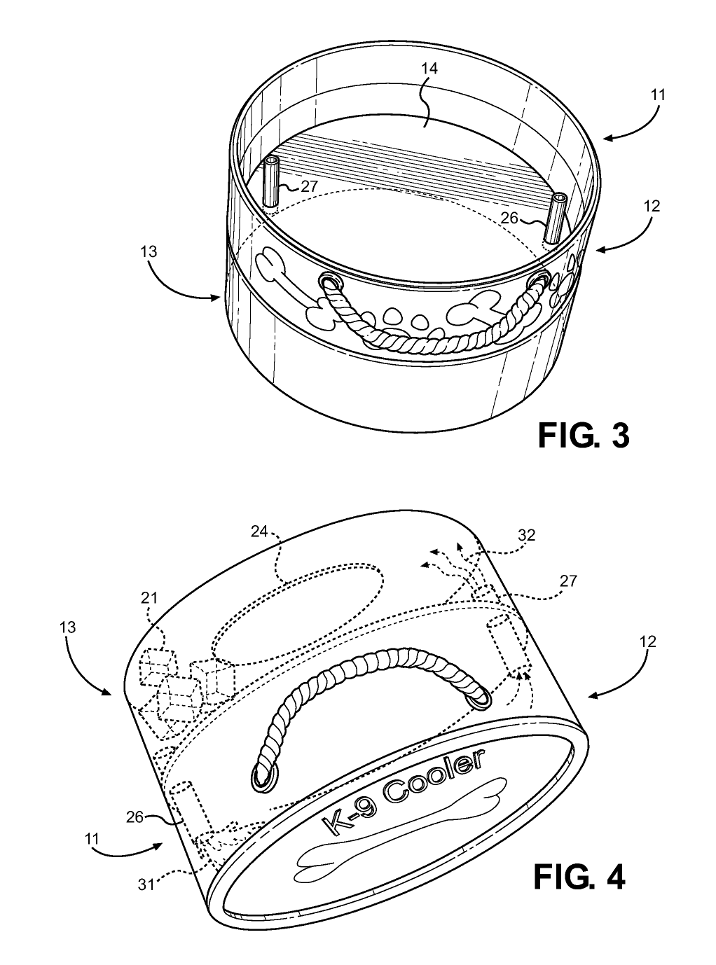

Referring now to FIG. 3, there is shown a perspective view of an alternate embodiment of the present invention, wherein a first and second filling tube is used to transfer water into the top compartment. In this embodiment, the device utilizes a first filling tube 26 and a second filling tube 27 for transferring water from the bottom compartment 13 into the top compartment 12. The tubes are preferably positioned on opposite sides of the bowl 11, and are disposed on the interior of the device between the top compartment and bottom compartment. The tubes are held in position by the divider 14, and create passage ways between the top and bottom compartment. The tubes comprise a cylinder with an opening that runs therethrough that resembles a section of a conventional drinking straw. The tubes allow water or melted ice to travel from the bottom compartment and into the top compartment.

The tubes are preferably configured so that a small section thereof penetrates into the top compartment, while a larger portion penetrates into the bottom compartment. This allows water or melted ice to accumulate on the divider when the bowl is oriented with the bottom compartment facing up. The extended height of the first and second tubes prevents the water from traveling into the top compartment when the bowl is oriented with the top compartment facing up. In this orientation, the water will accumulate on the lid and filling door (not shown), and be unable to flow into the top compartment. This allows the water to remain in the bottom compartment where the insulated lid will help the melted ice to retain its cold temperature. The water or melted ice will remain in the bottom compartment as long as the bowl is oriented with the top compartment facing up.

Referring now to FIG. 4, there is shown a perspective view of an alternate embodiment of the present invention, wherein water is traveling through the first filling tube into the top compartment from the bottom compartment. To fill the top compartment 12 with water 31 or melted ice 21, the user can position the pet bowl 11 so that the bottom compartment 13 is facing up, remove the filling door, fill the bottom compartment with water or ice, and close the door. The user can then travel with the pet bowl to a desired location. In this embodiment, the bowl should remain in an orientation with the top compartment facing up, which keeps the ice and water from accumulating on the filling door 24 and prevents it from traveling into the top compartment. When the pet requires water, the user can orient the device so that the top compartment is facing down and tilted to the side. The tilting of the lid causes the water to move towards either the first tube 26 or second tube 27. The water will then drain through the tube from the bottom compartment and into the top compartment. As one of the tubes provides a drain for the water, the other tube provides a vent for air 32 to travel from the top compartment and back into the bottom, thereby equalizing the pressure within the bowl. After a sufficient amount of water or melted ice has accumulated in the top compartment, the user can invert the bowl so that the top compartment is facing up. The extended height of the tubes prevents the water from draining back into the bottom compartment. The user can then remove the lid, and provide the bowl to the pet for consumption.

Overall, the present invention provides a convenient solution for providing water to pets in remote locations. Water or ice can be filled into the bottom compartment at home, and the device can be transported with the pet and user to a desired location. The insulated lid prevents the ice from rapidly melting, which allows the water to remain chilled for an extended period of time. This is particularly beneficial for use on hot days when dehydration occurs at an accelerated pace. The filling door and lid securely attach to the device, which prevents water from leaking out of the bowl while in transport. The device can be used while traveling on a road trip with a pet, when taking a day trip, or even for a short excursion to a dog park. The device additionally provides a convenient means of transporting water from home, which ensures that the pet will not become sick from drinking foreign sources of water.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A multi-compartment water bowl for a pet, comprising:
a top compartment having an open top and an annular sidewall that is adapted to receive water therein;
a bottom compartment, said bottom compartment having a lid and a removable filling door for providing access to said bottom compartment;
a divider that separates said top and bottom compartments to create two distinct areas within said bowl, said dividing having an access point between said top and bottom compartment;
a stopper that sealingly covers said access point in said divider;
an attachable lid for sealingly covering said top compartment open top.

2. The device of claim 1, wherein said bowl is large enough to be used as a water bowl for a domestic pet.

3. The device of claim 1, wherein said lid for said top compartment attaches to said open top with an attachment means.

4. The device of claim 3, wherein said attachment means comprises a means of engaging the side wall to create an airtight seal.

5. The device of claim 3, wherein said lid further comprises a rubber seal around the edge thereof to engage said top compartment in order to prevent water from leaking therethrough.

6. The device of claim 1, wherein said stopper is pressure fit into said access point in said divider to create a seal.

7. The device of claim 1, wherein said bowl includes a carrying handle affixed to either side of said top compartment.

8. The device of claim 1, wherein said bottom compartment lid is insulated.

9. The device of claim 1, wherein said bottom compartment filling door attaches to said insulated lid with a means of engaging said side wall to create an airtight seal.

10. The device of claim 1, wherein said bottom compartment filling door further comprises a rubber seal around the edge thereof to engage said bottom compartment lid in order to prevent water from leaking therethrough.

11. A multi-compartment water bowl for a pet, comprising:
a top compartment having an open top and an annular sidewall that is adapted to receive water therein;
a bottom compartment, said bottom compartment having a lid and a removable filling door for providing access to said bottom compartment;
a divider that separates said top and bottom compartments to create two distinct areas within said bowl;
a first filling tube and a second filling tube for transferring water from said bottom compartment into said top compartment; and
an attachable lid for sealingly covering said top compartment open top.

12. The device of claim 11, wherein said first and second filling tubes are positioned on opposite sides of said bowl and are disposed between said top and bottom compartment.

13. The device of claim 11, wherein said first and second filling tubes are held in position by said divider.

14. The device of claim 11, wherein said first and second filling tubes create passage ways between said top and bottom compartment.

15. The device of claim 11, wherein said first and second filling tubes further comprise a cylinder with an opening.

16. The device of claim 11, wherein said first and second filling tubes being positioned such that a small section of said tubes penetrate into said top compartment, while a larger portion of said tubes penetrates into said bottom compartment.
